(19) United States
(12) Patent Application Publication
(10) Pub. No.: US 2004/0007637 A1
(43) Pub. Date: Jan. 15, 2004

(54) Features for locking and driving a tape reel in a single reel tape cartridge

(76) Inventors: Henrik Vladimir Nejezchleb, Boulder, CO (US); Vladimir Nejezchleb, Boulder, CO (US)

Correspondence Address: PATTON BOGGS, PO BOX 270930, LOUISVILLE, CO, 80027, US

(21) Appl. No.: 10/194,913

(22) Filed: Jul. 12, 2002

(51) Int. Cl. G11B 23/107

(52) U.S. Cl. 242/348

(57) ABSTRACT

The features for locking and driving a tape reel in a single reel tape cartridge eliminate the dependence on friction for the mating (coupling) between the driving features and prevent the disengagement of the tape reel from a drive chuck due to high rotational forces. The geometry can be in the form of a post and hole arrangement or meshing teeth such that the rotational force is transmitted between the two bodies through mating surfaces that are perpendicular to the vector of the rotational force. This geometry still allows vertical motion of the bodies with respect to each other (i.e. they can be disengaged when desired) but the rotational force cannot translate into movement of one body with respect to the other body. The same geometry can be used to prevent the reel form being rotated when not in the tape drive.

### FIELD OF THE INVENTION

The invention relates to single reel tape cartridges that are used in tape drive data storage devices, and in particular, to a set of features formed on the tape reel and on the cartridge housing that are used to both drive and lock the tape reel in the single reel tape cartridge.

### Problem

It is a problem in the field of single reel tape cartridges that are used in tape drive data storage devices that the teeth of the drive chuck of the tape drive disengage the mating teeth on the tape reel when rotational forces overcome the frictional forces between the meshing teeth. The tape drive chuck rotates to impart rotational motion to the tape reel by the use of features on the tape drive chuck such as teeth, that mate with corresponding features on the hub of the tape reel. The rotation of the tape reel causes movement of the magnetic tape wound on the tape reel to or from the take-up reel that is located within the tape drive. A bias spring located within the tape cartridge forces the tape reel (and therefore the teeth) to engage the mating teeth on a drive chuck or feature on the tape drive. If the forces holding the drive chuck and the reel together become unbalanced, or if there are some other factors (i.e. gravity, reduction of friction, etc.) that reduce the integrity of the coupling, the features can disengage and cause failure in the tape drive.

This tape reel driving problem is exacerbated when the tape cartridge is oriented on its side (i.e. gravitational force perpendicular to the tape reel axis). Existing tape cartridges were designed to function in a flat orientation (gravity parallel to tape reel axis). When these existing tape cartridges are used in a vertical orientation, they experience failures due to the fact that they were not designed for this type of function and the tape reel is not properly engaged with the drive chuck due to the lack of a tight coupling between the driving features on the tape reel hub and the drive chuck. Tape cartridge libraries, automatic tape cartridge loading devices, and robotic tape cartridge handling apparatus frequently orient the tape drives vertically (on their sides) and encounter failures of the tape reel drive feature to engage with the mating drive feature located on the drive chuck of the tape drive.

A further problem is the locking of the tape reel in the tape cartridge housing to prevent the magnetic tape from unwinding as the tape cartridge is handled. There are numerous tape locks but they tend to be complex in nature and expensive to implement.

### Solution

The present features for locking and driving a tape reel in a single reel tape cartridge overcomes the problems outlined above and advances the art by eliminating the dependence on friction for the mating (coupling) between the driving features and prevent the disengagement of the tape reel from a drive chuck due to high rotational forces. The geometry can be in the form of a post and hole arrangement or meshing teeth such that the rotational force is transmitted between the two bodies through mating surfaces that are perpendicular to the vector of the rotational force. This geometry still allows vertical motion of the bodies with respect to each other (i.e. they can be disengaged when desired) but the rotational force cannot translate into movement of one body with respect to the other body. The same geometry can be used to prevent the reel form being rotated when not in the tape drive.

### BRIEF DESCRIPTION OF THE DRAWINGS

FIGS. 1 & 2 illustrate exploded top and bottom perspective views of a typical single reel tape cartridge equipped with the present features for locking and driving a tape reel and the associated drive chuck of the tape drive;

FIGS. 3A, 3B, 4A, 4B illustrate typical mating features that can be used in the present features for locking and driving a tape reel to interconnect the tape reel with the drive chuck;

FIGS. 5A, 5B illustrate typical mating features that can be used in the present features for locking and driving a tape reel to interconnect the tape reel with the tape cartridge housing;

FIG. 6 illustrates a cross-section view of the interconnection of the present features for locking and driving a tape reel; and

FIG. 7 illustrates a cross-section view of the interconnection of the features that are used in the prior art to interconnect the tape reel with the drive chuck.

### DETAILED DESCRIPTION OF THE DRAWINGS

For the purpose of illustration and not of limitation, various features and advantages of the present invention are described within the context of a single reel tape cartridge. It is to be understood that the following description with respect to a single reel tape cartridge is not intended to limit the scope of the present invention. It would be obvious to one skilled in the art that the principles of the present invention could be easily applied to other tape cartridge formats.

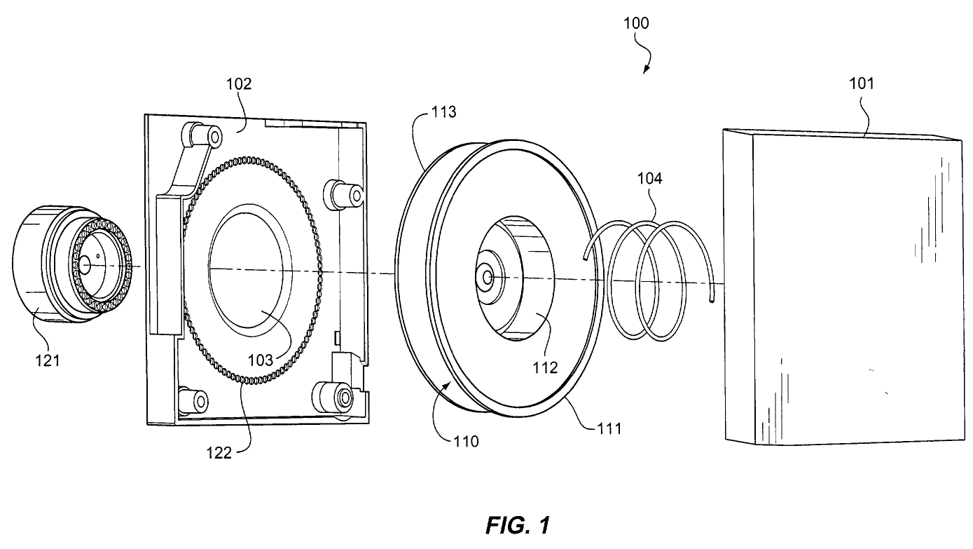

FIGS. 1 & 2 illustrate exploded top and bottom perspective views of a typical single reel tape cartridge equipped with the present features for locking and driving a tape reel and the associated drive chuck of the tape drive. The tape cartridge 100 consists of a two-part housing that includes a top section 101 and a bottom section 102 for enclosing the tape reel 110 and its associated magnetic tape (not shown). The tape reel 110 comprises a top flange 111 connected to a top portion of a tape reel hub 112 and a bottom flange 113 connected to a bottom portion of the tape reel hub 112. The tape reel hub 112 could be a conventional tape reel hub that connects to the tape drive in a conventional manner. The top and bottom flanges, 111 and 113, are connected in a parallel relationship and form a magnetic tape media containment section 114 on the tape reel hub 112. The tape media containment section 114 guides the tape media around the tape reel hub 112 during operation of the tape drive.

A drive chuck access hole 103 is formed in the bottom section 102 of the tape cartridge housing to enable the drive chuck 121 of the tape drive to engage the drive teeth 115 of the tape reel 110. A spring 104 applies a bias force to press the tape reel 110 against the drive feature (such as the drive chuck 121) in the tape drive when engaged to rotate the tape reel 110. One end of the spring 104 is seated in a spring sleeve (not shown) that is formed in the center of the interior surface of the top section 101 of the tape cartridge housing. The other end of the spring 104 engages the tape reel 110. In addition, locking features are provided to lock the tape reel 110 to the bottom section 102 of the tape cartridge housing to prevent rotation of the tape reel 110 unless the tape reel 110 is engaged with the drive chuck 121. These locking features comprise a plurality of locking elements 116 formed in a circular array on the bottom surface of the bottom flange 113, coaxial with the drive teeth 115 of the tape reel 110 and located toward the periphery of the bottom flange 113. These locking elements 116 mate with corresponding locking elements 122 formed in a matching pattern on the interior surface of the bottom section 102 of the tape cartridge housing.

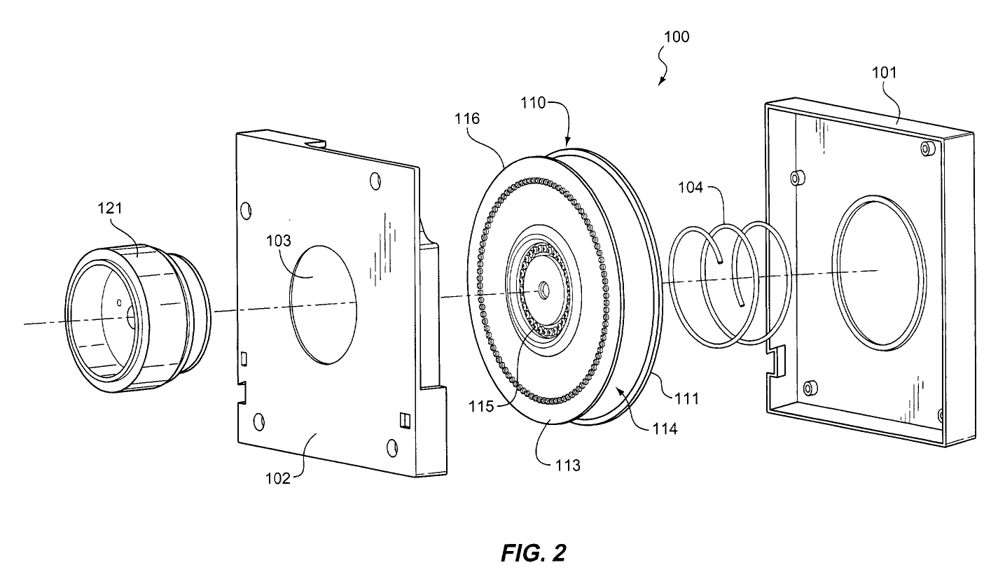

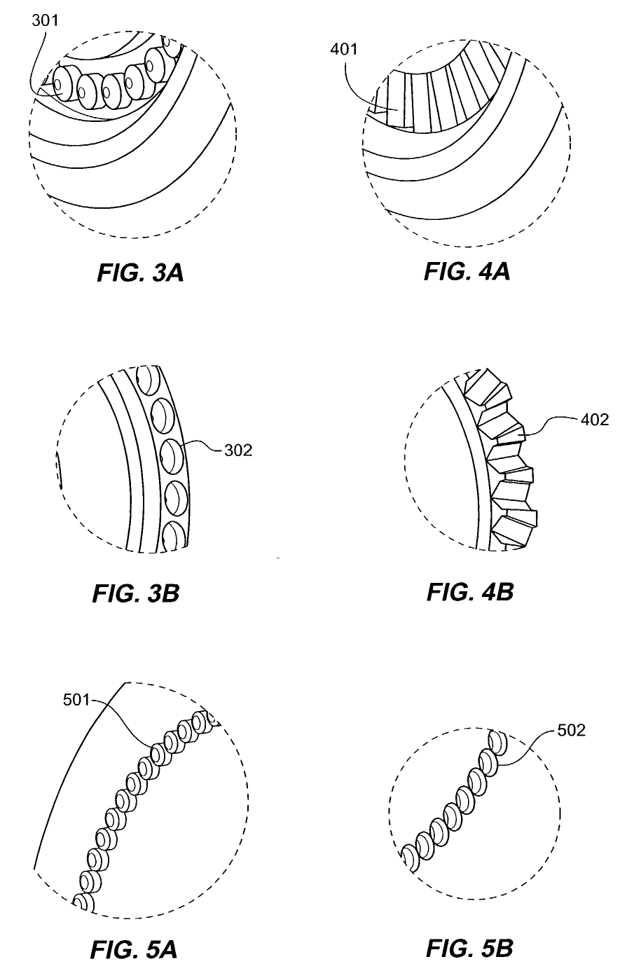

FIGS. 3A, 3B, 4A, 4B illustrate typical mating features that can be used in implementing the driving feature of the present features for locking and driving a tape reel. The driving feature functions to interconnect the tape reel 110 with the drive chuck 121. In FIGS. 3A & 3B, the tape reel 110 has driving features 301 that engage with corresponding driving features 302 on the drive chuck. In this configuration, the features are matching pins (posts) and holes. These features allow the drive chuck 121 to impart rotational motion to the tape reel 110 without slippage as described below. In FIGS. 4A & 4B, the tape reel 110 has driving features 401 that engage with corresponding driving features 402 on the drive chuck 121. In this configuration the features are mating teeth. These features allow the drive chuck 121 to impart rotational motion to the tape reel 110 without slippage as described below.

FIGS. 5A, 5B illustrate typical mating features that can be used to lock the tape reel 110 to the tape cartridge housing 102. The tape reel 110 has locking pins (posts) 501 which engage with locking holes 502 in the bottom section 102 of the tape cartridge housing. The locking features could also be teeth, or some other matching set of protrusions and depressions. These locking features allow the bottom section 102 of the tape cartridge housing to prevent rotational motion of the tape reel 110 (with respect to the tape cartridge housing). In operation, the spring 104 forces the tape reel 110 with its locking features 501 into engagement with the mating locking features on the interior surface of the bottom section 102 of the tape cartridge housing. When the tape cartridge 100 in inserted into the tape drive, the action of seating the tape cartridge 100 on the drive chuck 121 moves the tape reel 110 in a vertical direction and compresses the spring 104 to disengage the tape reel locking features 501 from the mating tape cartridge housing locking features 502. This enables the drive chuck 121 to rotate the tape reel 110.

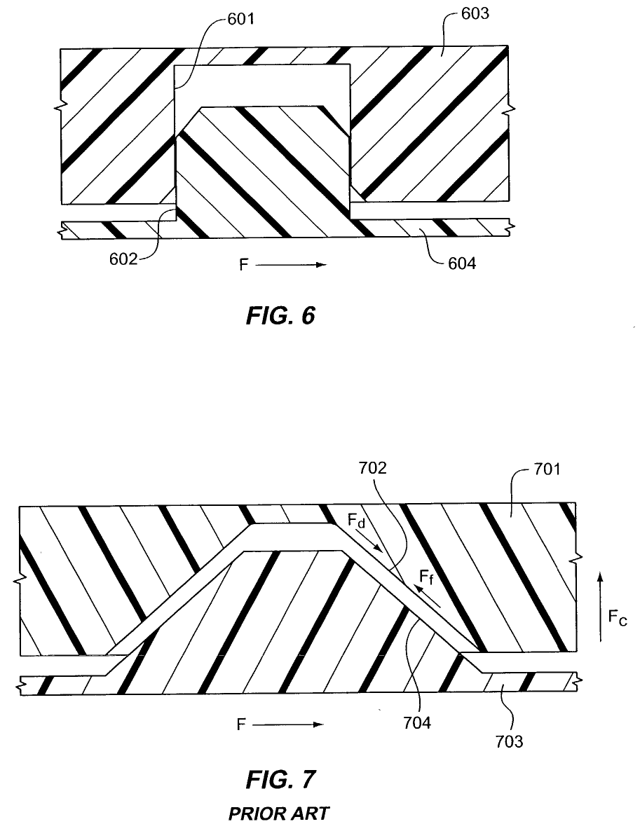

FIG. 6 illustrates a cross-section view of the interconnection of the present features for locking and driving a tape reel to illustrate the key to the novel geometry. When a force F is applied between Body 603 and Body 604 as shown (it is not important which body is imparting the force to the other body) the side walls of the two bodies come into contact. Since Vertical Wall 601 and Vertical Wall 602 are perpendicular to the force F, there is no dependence on friction to transmit the total force F between them. This geometry can be teeth, pin (post) and hole, or any geometry that provides vertical walls. The important feature is that the force is transmitted between the two bodies through mating surfaces that are perpendicular to the vector of the force. This geometry still allows vertical motion of the bodies with respect to each other (i.e. they can be disengaged when desired) but the force cannot translate into movement of Body 603 with respect to Body 604.

FIG. 7 illustrates a cross-section view of the interconnection of the features that are used in the prior art to interconnect the tape reel with the drive chuck to illustrate the existing prior art and the limitations of this form of interconnection. When a force F is applied between Body 701 and Body 703 as shown (it is not important which body is imparting the force to the other body) the side walls of the two bodies come into contact. Since Surface 702 and Surface 704 are not perpendicular to the force F, there is both an X and Y component of the force between the two surfaces. The Normal Coupling Force Fc (normally provided by the tape cartridge spring that forces Body 701 and Body 703 together) provides frictional force Ff between Surface 702 and Surface 704. When the force F (between Body 701 and Body 703) becomes great enough, the component Fd of force F along the interface between Surface 702 and Surface 704, overcomes the friction force Ff and the mating features disengage (move relative to each other in the vertical direction). At the limit, if the coefficient of friction between Body 701 and Body 703 is zero, it is impossible to impart a force between the two bodies as long as they can move with respect to each other in the vertical direction. Thus, the use of mating surfaces that are not perpendicular to the driving force always fail to maintain engagement, the only variable being the amount of force required to cause the lack of engagement.

### SUMMARY

Thus, the use of locking and/or driving features incorporating mating surfaces that are perpendicular to the force provides reliable driving engagement between the drive chuck and the tape reel, while the locking features of the tape reel and the tape cartridge housing provide reliable locking of the tape reel in the tape cartridge housing.

Those skilled in the art will appreciate that variations of the above-described embodiments fall within the scope of the invention. As a result, the invention is not limited to the specific examples and illustrations discussed above, but only by the following claims and their equivalents.

What is claimed:

1. A single reel tape cartridge that is configured to be loadable into a tape drive to read and write data on rewriteable media that is wound on the tape reel of the single reel tape cartridge, the single reel tape cartridge comprising:
a tape reel comprising:
a hub having connecting means formed in the bottom thereof for engaging a drive chuck located in the tape drive to enable rotation of said drive chuck to cause rotation of said tape reel,
a first flange connected to a top of the hub,
a second flange connected to a bottom of the hub in a parallel relationship with the first flange, wherein the first flange and the second flange define a tape containment section between said first and second flanges;
a housing for enclosing said tape reel;
locking means comprising a first set of features formed on a bottom of said second flange and a second set of features formed on an interior surface of said housing and juxtaposed to said first set of features for mating with said first set of features; and
wherein at least one of said locking means and said connecting means incorporates a plurality of mating surfaces that are perpendicular to a rotational force applied to said tape reel.

2. The single reel tape cartridge of claim 1 wherein said connecting means comprises:
a plurality of features formed on the bottom of said hub in a circular pattern coaxial with an axis of said tape reel and of dimensions to mate with a plurality of features formed on said drive chuck in a circular pattern coaxial with an axis of said tape reel.

3. The single reel tape cartridge of claim 2 wherein said housing comprises:
drive chuck access hole formed in said housing to enable said drive chuck to engage said connecting means on said tape reel.

4. The single reel tape cartridge of claim 3 further comprising:
spring means mounted between said housing and said tape reel for applying a bias force to press said tape reel against said drive chuck when said single reel tape cartridge is loaded into a tape drive.

5. The single reel tape cartridge of claim 1 wherein each of said plurality of features formed on the bottom of said hub comprises:
at least one surface perpendicular to a rotational force applied to said tape reel for mating with a corresponding surface on said drive chuck features that are perpendicular to a rotational force applied to said tape reel.

6. The single reel tape cartridge of claim 1 wherein said locking means further comprises:
wherein said first set of features comprises a plurality of features formed on the bottom of said hub in a circular pattern coaxial with an axis of said tape reel; and
wherein said second set of features comprises a plurality of features formed on an internal surface of said housing in a circular pattern coaxial with an axis of said tape reel for engaging said plurality of features formed on the bottom of said hub.

7. The single reel tape cartridge of claim 6 wherein said housing comprises:
drive chuck access hole formed in said housing to enable said drive chuck to engage said connecting means on said tape reel.

8. The single reel tape cartridge of claim 7 further comprising:
spring means, mounted between said housing and said tape reel, for applying a bias force to press said first set of features formed on a bottom of said second flange against said second set of features formed on an interior surface of said housing to lock said tape reel from rotating.

9. The single reel tape cartridge of claim 8 wherein said locking means comprises:
each of said plurality of features in said first set comprises at least one surface perpendicular to a rotational force applied to said tape reel;
each of said plurality of features in said second set comprises at least one surface perpendicular to a rotational force applied to said tape reel; and
wherein said perpendicular surfaces of said features of said first set and said second set are mating surfaces.

10. A single reel tape cartridge that is configured to be loadable into a tape drive to read and write data on rewriteable media that is wound on the tape reel of the single reel tape cartridge, the single reel tape cartridge comprising:
a tape reel comprising:
a hub,
a first flange connected to a top of the hub,
a second flange connected to a bottom of the hub in a parallel relationship with the first flange, wherein the first flange and the second flange define a tape containment section between said first and second flanges;
a housing for enclosing said tape reel; and
locking means comprising a first set of features formed on a bottom of said second flange and a second set of features formed on an interior surface of said housing and juxtaposed to said first set of features for mating with said first set of features wherein said locking means incorporates a plurality of mating surfaces that are perpendicular to a rotational force applied to said tape reel.

11. The single reel tape cartridge of claim 10 wherein said locking means further comprises:
wherein said first set of features comprises a plurality of features formed on the bottom of said hub in a circular pattern coaxial with an axis of said tape reel; and
wherein said second set of features comprises a plurality of features formed on an internal surface of said housing in a circular pattern coaxial with an axis of said tape reel for engaging said plurality of features formed on the bottom of said hub.

12. The single reel tape cartridge of claim 10 further comprising:
connecting means formed in the bottom of said hub for engaging a drive chuck located in the tape drive to enable rotation of said drive chuck to cause rotation of said tape reel; and
drive chuck access hole formed in said housing to enable said drive chuck to engage said connecting means.

13. The single reel tape cartridge of claim 12 further comprising:
spring means, mounted between said housing and said tape reel, for applying a bias force to press said first set of features formed on a bottom of said second flange against said second set of features formed on an interior surface of said housing to lock said tape reel from rotating.

14. The single reel tape cartridge of claim 13 wherein said connecting means comprises:
a plurality of features formed on the bottom of said hub in a circular pattern coaxial with an axis of said tape reel and of dimensions to mate with a plurality of features formed on said drive chuck in a circular pattern coaxial with an axis of said tape reel.

15. The single reel tape cartridge of claim 14 wherein each of said plurality of features formed on the bottom of said hub comprises:
at least one surface perpendicular to a rotational force applied to said tape reel for mating with a corresponding surface on said drive chuck features that are perpendicular to a rotational force applied to said tape reel.

16. The single reel tape cartridge of claim 10 wherein said locking means comprises:
each of said plurality of features in said first set comprises at least one surface perpendicular to a rotational force applied to said tape reel;
each of said plurality of features in said second set comprises at least one surface perpendicular to a rotational force applied to said tape reel; and
wherein said perpendicular surfaces of said features of said first set and said second set are mating surfaces.
